(19) United States
(12) Patent Application Publication
(10) Pub. No.: US 2014/0035227 A1
(43) Pub. Date: Feb. 6, 2014

(54) COIN OPERATED GAME DEVICE USING LEDS TO PROVIDE GENERAL ILLUMINATION

(71) Applicants: Steve Ritchie, Lombard, IL (US); Lyman Sheats, Hoffman Estates, IL (US)

(72) Inventors: Steve Ritchie, Lombard, IL (US); Lyman Sheats, Hoffman Estates, IL (US)

(73) Assignee: STERN PINBALL, INC., Melrose Park, IL (US)

(21) Appl. No.: 13/567,831

(22) Filed: Aug. 6, 2012

(51) Int. Cl. G07F 17/32

(52) U.S. Cl. CPC G07F 17/3295
USPC 273/121 A

(57) ABSTRACT

A coin operated amusement game such as a pinball machine having a playing surface wherein tri-colored LEDs are provided to illuminate the game playing surface.

### BACKGROUND

Using LEDs as an illumination source is generally know in the art. For example, Published Application No. WO 2006/001221 describes an illumination source composed of a white LED of a first light source color and an orange LED of a second light source color so that light is emitted in a color created as a result of mixing the first and second light source colors and Published Application No. US 2005/0152141 describes an illumination source that uses a plurality of LEDs arranged to emit light into a light guide wherein the plurality of LEDs can emit different colored lights.

Using an illumination source to illuminate a pinball machine is also generally known in the art. For example, Patent No. U.S. Pat. No. 5,091,677 describes a lighting control system for a pinball machine that employs a lighting circuit board that supports at least one string of lamps connected in parallel; Patent No. U.S. Pat. No. 5,944,309 describes an illuminable ramp assembly for a pinball machine wherein a gas tube is used as the illumination source; Published Application No. EP 0992264 describes a pinball machine having driving circuits operatively coupled to one or more illumination devices disposed on a playfield, and Published Application No. US 2008/0036143 describes a pinball machine having a playfield to which LEDs are mounted as a means for illuminating portions of playfield. In addition, the TRON pinball game machine included a light source in the form of light pipes that were positioned around the edges of ramps placed on the playfield.

### SUMMARY

The following describes a system and method for using LEDs, particularly tri-colored LEDS, as a source of general illumination for a coin operated game device, such as a pinball machine.

A better understanding of the objects, advantages, features, properties and relationships of the system and method will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the system and method for using LEDs as a source of general illumination in a coin operated game device, reference may be had to the following drawings in which:

FIG. 1 is an isometric view of a coin operated game device, in the exemplary form of a pinball machine, using LEDs as a source of general illumination; and

FIG. 2 is a top view, partially transparent, of an exemplary playing surface of the coin operated game device of FIG. 1.

### DETAILED DESCRIPTION

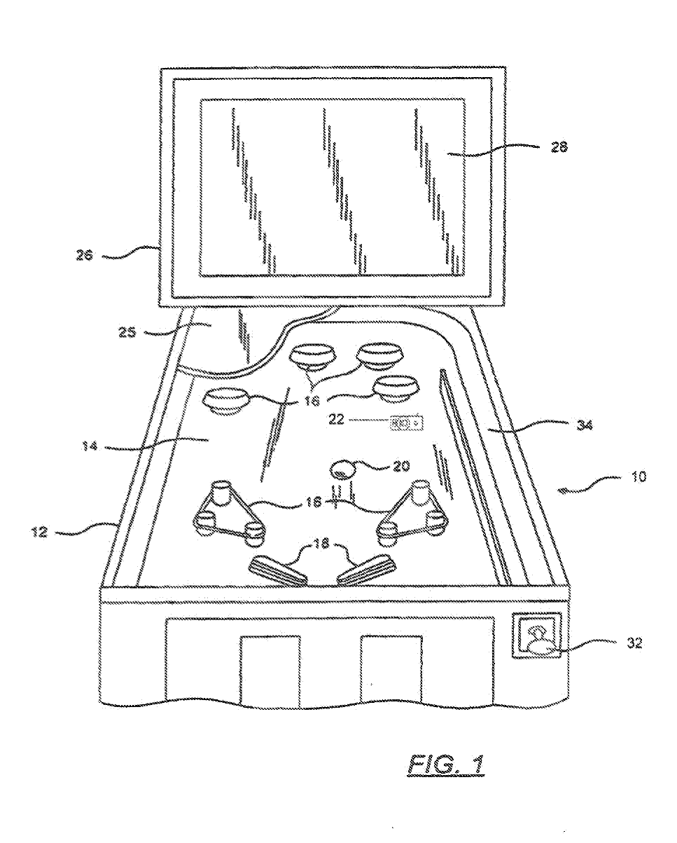

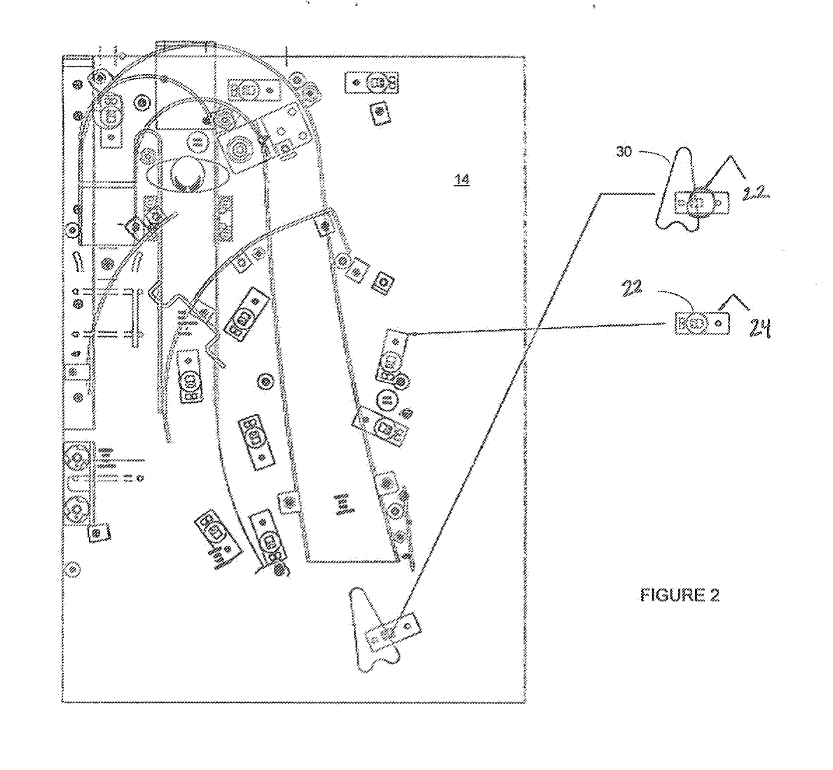

With reference to the FIGS. 1 and 2, a coin operated game device, in the exemplary form of a pinball machine 10 similar to that shown in Patent Application EP 0992264 but capable of being generally illuminated, is now described. More particularly, the coin operated game device 10 includes a cabinet 12, generally illuminated as described hereinafter, which houses various apparatus used to define play of a game. Game play is typically commenced in response to insertion of money—paper or coins referred to collectively as “coins”—into a coin accepting device or upon exercising of credits earned. Upon activation of the game in this manner, game play, in the case of a pinball machine, is defined upon an inclined playfield 14 that supports a number of playfield accessories or devices 16. More particularly, in the case of a pinball machine, game play is generally defined through the use of a pair of flippers 18 to propel a ball 20 relative to the playfield and accessories/devices associated with the playfield 14. The playfield 14 is usually inclined from the horizontal such that the ball 20 tends to eventually roll back down the playfield 14 in the direction of the flippers 18. While not intended to be limiting, the playfield apparatus 16 may include elements such as bumpers, ramps, and/or targets. The playfield 14 may be covered by a transparent or glass sheet 25 to permit viewing of the playfield 14. In addition to the foregoing, the playfield 14 usually includes a plunger element 32 which shoots the ball 20 up an alley 34 onto the playfield 14. Other player-activated elements, typically in the form of push-buttons (not shown) on the sides of the cabinet 12, are usually provided for controlling operation of the flippers 18. The pinball machine 10 may also includes a backbox 26 which is mounted to overlay a top rear portion of the cabinet 12 and which contains a game display 28, such as a dot matrix display, CRT, or the like type of display device. The backbox 26 may also support speakers (not illustrated) associated with the game sound system. Within the backbox 26 may be located various of the electronic circuits for controlling the operation of the playfield, the display, general illumination, and the sound system.

To generally illuminate the coin operated device 10, the playfield 14 is provided with illumination devices 22 which may be mounted to an underside of the playfield 14 using mounting hardware 24. In addition or alternatively, the illumination devices 22 may be mounted above the playfield 14, for example by being mounted to a play feature or the like. The illumination devices 22 are mounted to allow for the light emitted from the illumination devices 22 to generally illuminate the entirety of or a desired portion of the playing interior of the coin operated device 10. Since, in the case of pinball machine, the ball 20 may roll over an area of the playfield to which the illumination devices 22 are mounted, a generally transparent overlay 30 may be provided to the playfield 14 in a location over the illumination devices 22 when mounted below the rolling ball playing surface. The illumination devices 22 preferably include tri-colored LEDs, e.g., red, green, and blue colored LEDs, which are controllable in a known manner to vary the intensity of the light emitted therefrom such that the illumination devices 22 may illuminate the playfield or portions thereof in one or more of a plurality of different colors. To this end, the illumination devices 22 may be provided power under the control of a system bus architecture or may be provided power by a dedicated illumination circuit.

In a further preferred embodiment, the LEDs are used to illuminate the playfield in a given color based upon a game play mode of the pinball machine. For example, a pinball machine might support a plurality of different game play modes each having a set of rules for interacting with the various apparatus used to define play of a game. Each of the plurality of different game play modes is associated with a corresponding one of a plurality of colors. In this manner, the LEDs can then be controlled to thereby illuminate the playfield in a one of a plurality of different colors (e.g., the playfield may be illuminated in red, blue, purple, etc.) to thereby indicate to the user a corresponding one of a plurality of game play modes in which the pinball machine will be operating. By way of further example, the pinball machine may allow a user to select from amongst a plurality of songs that they want to hear throughout game play. Each of the plurality of different songs can be associated with a corresponding one of a plurality of colors. In this manner, the LEDs can then be controlled to thereby illuminate the playfield in a one of a plurality of different colors corresponding to a one of the plurality of songs that will be played during game play of the pinball machine.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalents thereof.

All patents, patent applications, and other references cited within this document are hereby incorporated by reference in their entirety.

What is claimed is:

1. A coin operated amusement game, comprising:
a playfield including a plurality of features which are utilized to define play of the coin operated amusement game; and
a plurality of tri-colored LEDs positioned in cooperation with the playfield to illuminate a playing surface of the playfield in a one of a plurality of different colors.

2. The coin operated amusement game of claim 1, wherein the plurality of tri-colored LEDs are positioned below the playing surface of the playfield.

3. The coin operated amusement game of claim 1, wherein the plurality of tri-colored LEDs are positioned above the playing surface of the playfield.

4. The coin operated amusement game of claim 1, wherein the one of the plurality of different colors in which the playing surface of the playfield is illuminated corresponds to a one of a plurality of different game play modes of the coin operated amusement game.

5. The coin operated amusement game of claim 1, wherein the one of the plurality of different colors in which the playing surface of the playfield is illuminated corresponds to a one of a plurality of songs that will be played during game play of the coin operated amusement game.

6. The coin operated amusement game as recited in claim 1, wherein the playfield comprises an inclined playfield of a pinball machine.
